(19) United States
(12) Patent Application Publication
(10) Pub. No.: US 2022/0285767 A1
(43) Pub. Date: Sep. 8, 2022

(54) BATTERY WATERTIGHTNESS STRUCTURE AND METHOD

(71) Applicant: HYUNDAI MOBIS Co., Ltd., Seoul (KR)

(72) Inventor: Sang Woo Kim, Yongin-si (KR)

(73) Assignee: HYUNDAI MOBIS Co., Ltd., Seoul (KR)

(21) Appl. No.: 17/684,713

(22) Filed: Mar. 2, 2022

(30) Foreign Application Priority Data
Mar. 2, 2021 (KR) 10-2021-0027684
Mar. 2, 2021 (KR) 10-2021-0027685

(51) Int. Cl. H01M 50/186; H01M 50/567

(52) U.S. Cl. CPC H01M 50/186; H01M 50/567

(57) ABSTRACT

A battery watertightness structure includes a first member, a second member that covers the first member, a gasket located between the first member and the second member, assembly hardware fixed to a hole formed in the first member, and counterpart assembly hardware that is assembled with the assembly hardware through a hole formed in the second member and fastens the first member and the second member and the gasket therebetween. A height of a portion of the assembly hardware, which is located between the first member and the second member, is configured to support a compression limit of the gasket against an axial force when the counterpart assembly hardware is assembled between the first member and the second member.

### CROSS-REFERENCE TO RELATED APPLICATION

This application claims priority to and the benefit of Korean Patent Application No. 10-2021-0027684, filed on Mar. 2, 2021 and Korean Patent Application No. 10-2021-0027685, filed on Mar. 2, 2021, the disclosures of which are incorporated herein by reference in their entirety.

### BACKGROUND

### 1. Field of the Invention

The present invention relates to a battery for an electric vehicle, and more particularly, to a technology for improving watertightness of a battery using assembly hardware.

### 2. Discussion of Related Art

Gaskets are used for watertight sealing of batteries used in electric vehicles, motor vehicles, and various other fields.

FIG. 1A is a schematic view of a gasket for watertightness of a battery. A gasket 3 is provided in a battery casing 2, and the gasket 3 made of rubber is compressed during assembly to block a water penetration path (watertight action). However, when only the gasket 3 is simply used, since there is a risk that the gasket 3 is not firmly fixed and thus watertightness may be degraded, the gasket 3 is used while a plurality of bushes 1 made of a metal are coupled to the gasket 3.

FIG. 1B is an exemplary view of the bush 1 used to be coupled to a gasket for watertightness of a battery. The bush 1 fitted in the gasket 3 and made of steel supports an axial force due to torque when assembly hardware is fastened. In general, the shape of the bush 1 is a cylindrical shape having flanges 4 and 4′ formed on an upper surface and a lower surface thereof, fitted in the gasket 3, and having a hollow 5 formed in a center thereof so that the assembly hardware passes therethrough.

### SUMMARY OF THE INVENTION

A bush that supports an axial force due to fastening torque is coupled to a gasket, but the gasket and the bush are not integrated, and thus the bush should be forcibly fitted in the gasket in a manual manner. This increases a cycle time and production costs, and when the gasket is moved, the bush is often separated, resulting in quality problems. Further, when assembly hardware (bolts, nuts, and the like) is tightened and loosened several times, a flange part (a part fixed to a rubber gasket) of the bush may be bent, which causes damage and permanent deformation of the gasket (rubber material). Due to this problem, the fastening torque of the assembly hardware is loosened, compression of the gasket is not ensured, and thus moisture may flow into a battery.

Thus, the purpose of the present invention is to propose a battery watertightness structure for solving these problems.

According to an aspect of the present invention, there is provided a battery watertightness structure including a first member, a second member that covers the first member, a gasket located between the first member and the second member, assembly hardware fixed to a hole formed in the first member, and counterpart assembly hardware that is assembled with the assembly hardware through a hole formed in the second member and fastens the first member and the second member and the gasket therebetween. A height of a portion of the assembly hardware, which is located between the first member and the second member, is configured to support a compression limit of the gasket against an axial force when the counterpart assembly hardware is assembled between the first member and the second member.

The present invention will become clearer through detailed embodiments described below with reference to the drawings.

### BRIEF DESCRIPTION OF THE DRAWINGS

The above and other objects, features and advantages of the present invention will become more apparent to those of ordinary skill in the art by describing exemplary embodiments thereof in detail with reference to the accompanying drawings, in which:

FIG. 1A is a schematic view of a gasket for watertightness of a battery;

FIG. 1B is an exemplary view of a bush used to be coupled to the gasket;

FIG. 2 is an exploded view of a battery system for an electric vehicle according to a related art;

FIGS. 3A and 3B are detailed views of an insert bolt and an insert nut (12) insert-mounted on a case of FIG. 2;

FIG. 4 illustrates a state in which a bush is fitted in a gasket of FIG. 2;

FIG. 5 is a cross-sectional view of a state in which components of FIGS. 2 to 4 are assembled;

FIG. 6 is an assembly view of another battery system assembly (BSA) for an electric vehicle according to a related art;

FIG. 7 is an exploded view of a maintenance window (40) that is present in a cover of FIG. 6;

FIG. 8 is a detailed view of a portion of the cover of FIG. 6 in which a blind nut is press-fitted;

FIG. 9 illustrates a state in which a bush is fitted in a gasket of FIG. 6;

FIG. 10 is a cross-sectional view of a state in which components of FIGS. 6 to 9 are assembled;

FIG. 11 is a cross-sectional view illustrating a battery watertightness structure according to an embodiment of the present invention;

FIG. 12 is a cross-sectional view illustrating a battery watertightness structure according to a modified embodiment of FIG. 11;

FIG. 13 is a cross-sectional view illustrating a battery watertightness structure according to another embodiment of the present invention;

FIG. 14 is a cross-sectional view illustrating a battery watertightness structure according to a modified embodiment of FIG. 13; and

FIG. 15 is a modified embodiment in which a blind nut according to the embodiment of FIG. 13 is replaced with a blind bolt.

### DETAILED DESCRIPTION OF EXEMPLARY EMBODIMENTS

Hereinafter, exemplary embodiments of the present invention will be described in detail with reference to the accompanying drawings. Advantages and features of the present invention and a method of achieving the advantages and the features will become apparent with reference to embodiments described below in detail together with the accompanying drawings. Terms used in the present specification are intended to describe the embodiments and are not intended to limit the present invention. In the present specification, a singular form also includes a plural form unless specifically mentioned. The term “comprise” or “comprising” used herein does not exclude the presence or addition of one or more other components, steps, operations, and/or elements in addition to components, steps, operations, and/or elements described above.

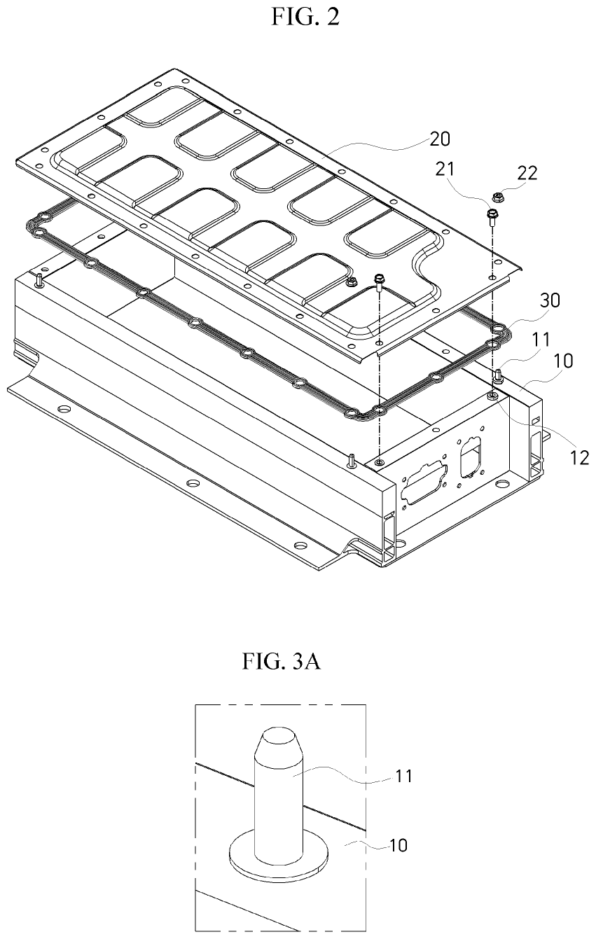

FIG. 2 is an exploded view of a battery system assembly (BSA) for an electric vehicle according to an example.

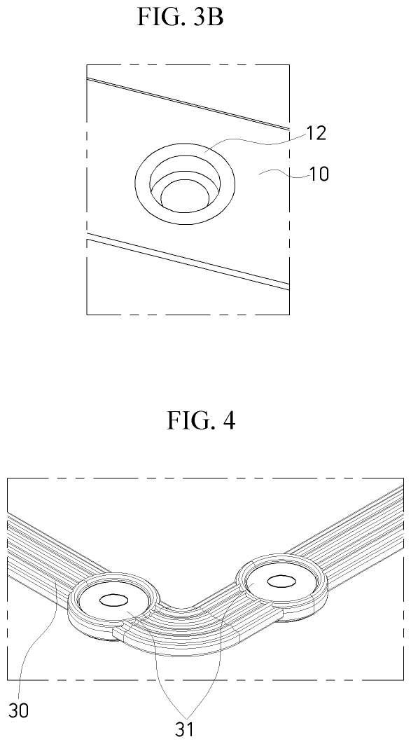

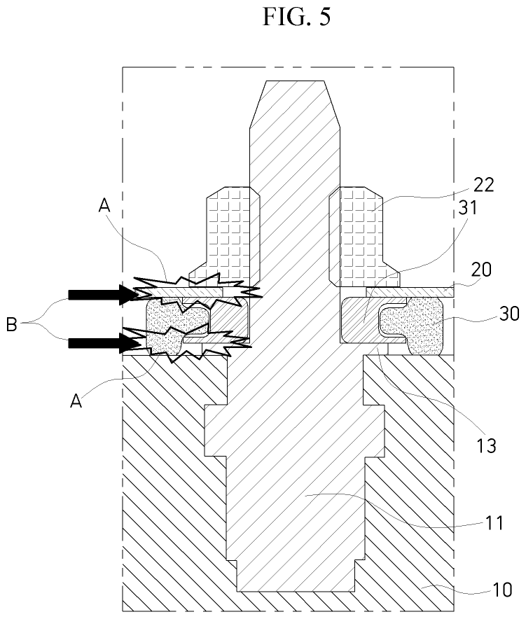

A battery is installed in a space of a case 10 made of a synthetic resin or a metal (steel, aluminum, or the like), and a cover 20 made of a synthetic resin, a metal, or the like is also covered. Before the cover 20 is fixed to the case 10, a gasket 30 made of rubber is fitted therebetween, and a fastening bolt 21 and/or a fastening nut 22 that are assembly hardware are fastened through a through-hole formed in the cover 20. In order to fasten the assembly hardware 21 and/or 22, a plurality of assembly hardware, for example, an insert bolt 11 and/or an insert nut 12, are insert-molded around the case 10. Further, a bush (see FIG. 4), which is made of steel to support an axial force due to fastening torque during bolting, is fitted in the gasket 30 at each location through which the fastening bolt 21 or the insert bolt 11 passes.

FIGS. 3A and 3B are detailed views of the insert bolt 11 (left side) and the insert nut 12 (right side) insert-mounted on the case 10. When the cover 20 is assembled to the case 10, the fastening bolt 21 and the fastening nut 22 that are counterpart assembly hardware are fastened to the insert bolt 11 and the insert nut 12. In the embodiment of FIG. 2, it is exemplified that both the insert bolt 11 and the insert nut 12 are used in one BSA, but the present invention is not limited thereto.

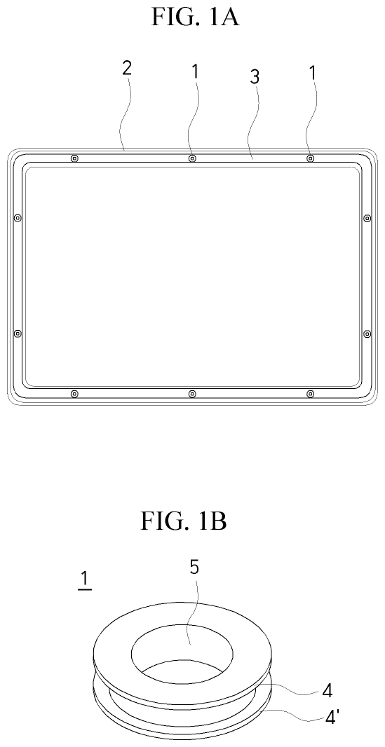

FIG. 4 illustrates a state in which a bush 31 is fitted in the gasket 30. A hole (through-hole of the fastening bolt 21 and the insert bolt 11) formed in the gasket 30 made of rubber is widened using an elastic force, and the hollow cylindrical bush 31 made of steel and having flanges formed on upper and lower surfaces thereof as illustrated in FIG. 1B is coupled to the hole in a forcible fitting manner.

FIG. 5 is a detailed cross-sectional view of a state in which components described in FIGS. 2 to 4 are assembled. The insert bolt 11 is insert-molded in the case 10 of the BSA, and the bush 31 is fitted in the gasket 30. Accordingly, an upper portion of the gasket 30 is in contact with a lower surface of the cover 20 thereabove and a lower portion of the gasket 30 is in contact with an upper surface of the case 10 of the BSA therebelow to achieve a watertight action.

Here, an upper flange part of the bush 31 is in contact with the lower surface of the cover 20 thereabove, and a lower flange part of the bush 31 is in contact with an embedded flange 13 of the insert bolt 11 therebelow. Thus, as described above in the summary, as fastening between the fastening nut 22 and the insert bolt 11 is repeated several times, the flange part of the bush 31 is deformed, for example, is bent, and the gasket 30 may be damaged or permanently deformed. Accordingly, loosening of the fastening between the fastening nut 22 and the insert bolt 11 due to torque may be induced (mark A), and compression of the gasket is not ensured, and thus moisture may flow into the battery (mark B).

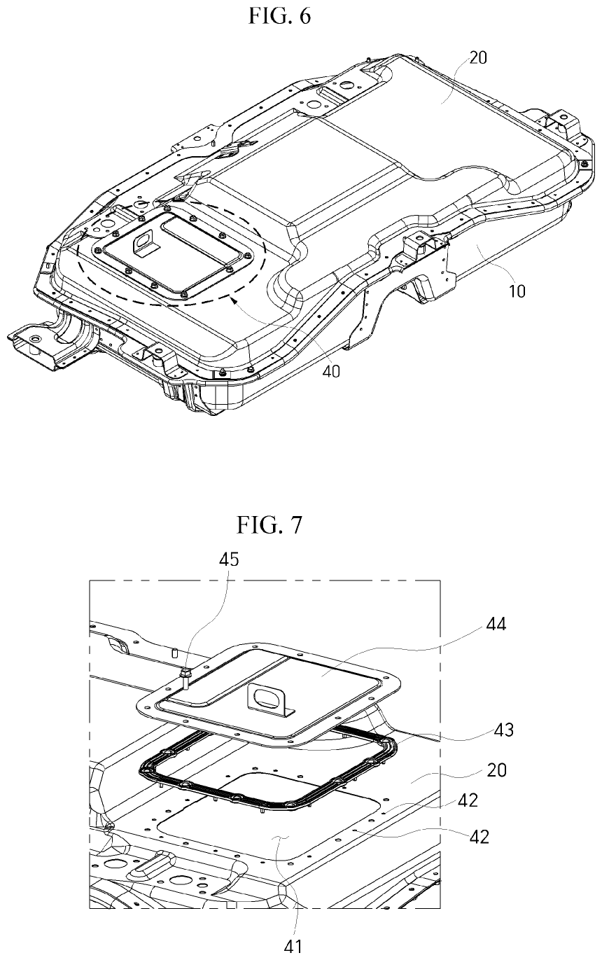

FIG. 6 is an assembly view of another BSA for an electric vehicle according to a related art. The battery is installed in a space between the case 10, which is located at a lower side, and the cover 20. In FIG. 6, a part 40 is a maintenance window that is opened or closed so that a specific part may be repaired without entirely disassembling the BSA.

FIG. 7 is an exploded view of a maintenance window 40 that is present in the cover 20 made of a steel or aluminum extrusion material. A gasket 43 made of rubber is covered around a maintenance window hole 41 passing through the cover 20, a maintenance window cover 44 is covered on the gasket 43, and a plurality of fastening bolts 45 are fastened through penetration holes formed in the maintenance window cover 44. In order to fasten these fastening bolts 45, a plurality of blind nuts 42 are press-fitted around the maintenance window hole 41. Further, a bush (see FIG. 9), which is made of steel to support upper and lower compression limits of the gasket 43 against an axial force due to torque when the bolt is fastened, is fitted in the gasket 43 at each location through which the bolt passes.

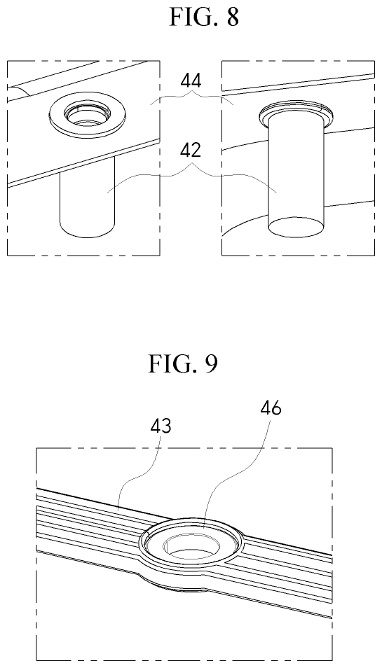

FIG. 8 is a detailed view of a portion of the maintenance window cover 44 in which the blind nut 42 is press-fitted. The left side is a top view of the maintenance window cover 44, and the right side is a bottom view of the maintenance window cover 44. A blind bolt (described below) instead of the blind but 42 may be press-fitted in the maintenance window cover 44.

FIG. 9 illustrates a state in which a bush 46 is fitted in the gasket 43. A bolt through-hole formed in the gasket 43 made of rubber is widened with an elastic force, and the hollow cylindrical bush 46 made of steel and having flanges formed on upper and lower surfaces thereof as illustrated in FIG. 1B is forcibly fitted in the hole.

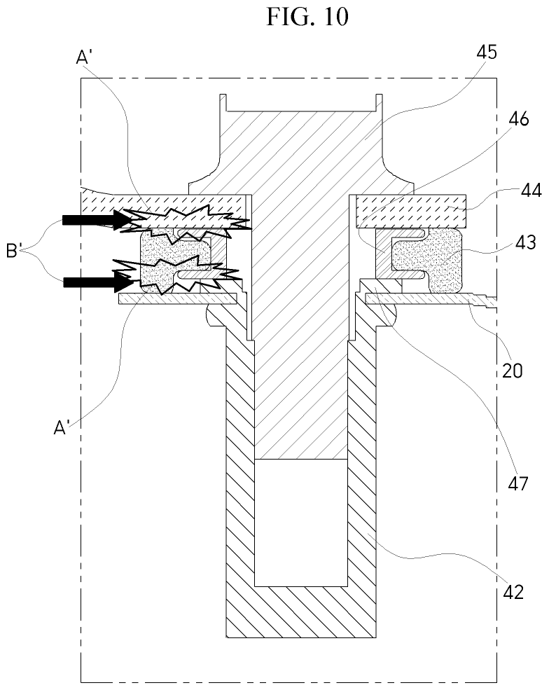

FIG. 10 is a detailed cross-sectional view of a state in which components described in FIGS. 6 to 9 are assembled. Referring to FIG. 10, the blind nut 42 is press-fitted in the cover 20 of the BSA, and the bush 46 is fitted in the gasket 43. Accordingly, an upper portion of the gasket 43 is in contact with a lower surface of the maintenance window cover 44 thereabove and a lower portion of the gasket 43 is in contact with an upper surface of the cover 20 of the BSA therebelow to achieve a watertight action.

Here, an upper flange part of the bush 46 is in contact with the lower surface of the maintenance window cover 44 thereabove, and a lower flange part of the bush 46 is in contact with a head part flange 47 of the blind nut 42 therebelow. Thus, as described above in the summary, as fastening between the fastening bolt 45 and the blind nut 42 is repeated several times, the flange part of the bush 46 is deformed, for example, is bent, and the gasket 43 may be damaged or permanently deformed. Accordingly, loosening of the fastening between the fastening bolt 45 and the blind nut 42 due to torque may be induced (mark A′), and compression of the gasket 30 is not ensured, and thus moisture may flow into the battery (mark B′).

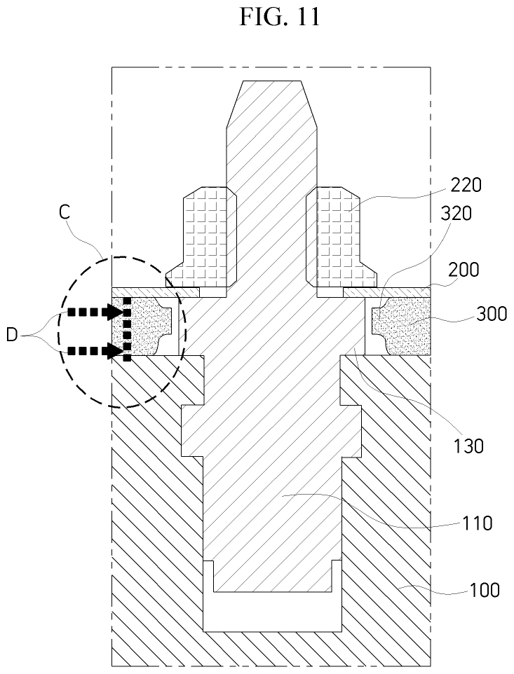

FIG. 11 is a cross-sectional view illustrating a battery watertightness structure according to the embodiment of the present invention, which is obtained by improving the gasket/bush-based battery watertightness structure according to the related art. The present embodiment relates to a battery watertightness structure when assembly hardware (in the present embodiment, an insert bolt 110) is inserted into and protrudes upward of a case 100 of the BSA. Similar to the case of FIG. 5, a gasket 300 is fitted between the case 100 and a cover 200. Further, a fastening nut 220 that is counterpart assembly hardware is fitted in the insert bolt 110 protruding to pass through through-holes of the cover 200 and the gasket 300, and thus the gasket 300, the case 100, and the cover 200 are fastened.

However, unlike the related art, in the present embodiment, the gasket 300 does not have the bush 31 (in FIG. 5). Instead, the thickness (height) of a flange 130 of the insert bolt 110 located between the case 100 and the cover 200 is increased, and thus this increase corresponds to a form in which the existing bush is located between the case 100 and the cover 200. Accordingly, the problem of deformation of the flange part of the bush, when the counterpart assembly hardware (that is, the fastening nut 220) is fastened, due to a relatively weak flange structure of the bush can be overcome. At the same time, the insert bolt 110 instead of the bush may withstand (counter) the axial force when the counterpart assembly hardware is fastened, to support the compression limit of the gasket 300, and thus fastening torque can be maintained.

Further, an inner extension 320 is added so that a gasket flesh is further inserted into the through-hole of the gasket 300 to surround the flange 130 of the insert bolt 110. As the gasket 300 is compressed between the case 100 and the cover 200, the inner extension 320 is further inserted and expanded into the through-hole and thus may approach or come into close contact with a side surface of the flange 130 of the insert bolt 110. Further, since there is no bush in the gasket 300, the watertightness between the case 100 and the cover 200 is completely operated by the compression of the gasket 300, and thus penetration of moisture into a corresponding space (mark C) therebetween is blocked (mark D).

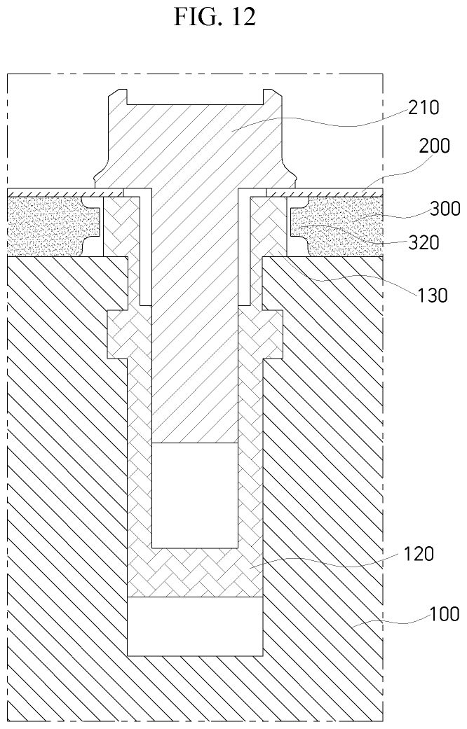

FIG. 12, which is a view for describing another embodiment of the present invention, is a cross-sectional view illustrating a battery watertightness structure when not the insert bolt 110 but an insert nut 120 as the assembly hardware is inserted into the case 100 unlike the structure of FIG. 11.

The insert nut 120 is inserted into the case 100 of the BSA, and the gasket 300 is fitted between the case 100 and the cover 200. Further, a fastening bolt 210 that is counterpart assembly hardware is fitted in the insert nut 120 to pass through the through-holes of the cover 200 and the gasket 300, and thus the gasket 300, the case 100, and the cover 200 are fastened. The improvement of the watertight action of the gasket 300 and the effect thereof is similar to the case of FIG. 11. That is, there is no existing bush, the bush is replaced with the flange 130 of the insert nut 120 located between the case 100 and the cover 200, and the extension 320 is formed inside the gasket 300.

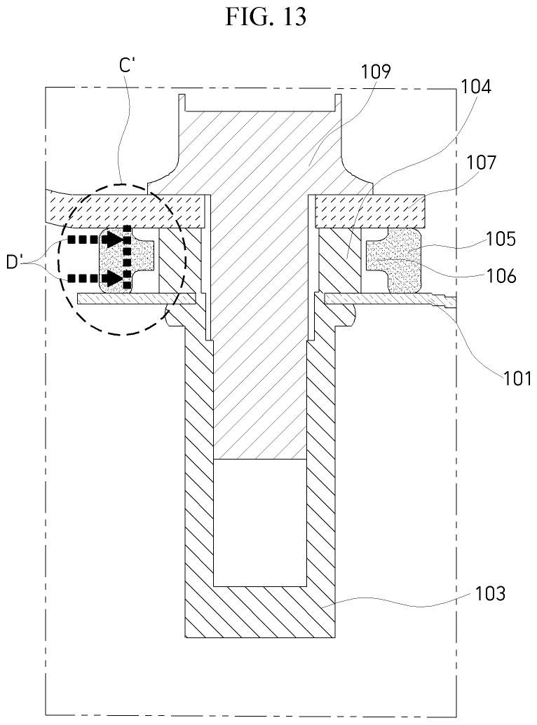

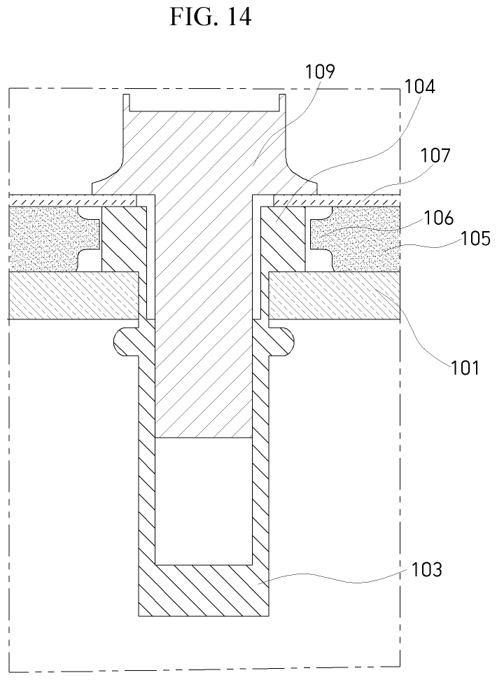

FIG. 13 is a cross-sectional view illustrating a battery watertightness structure according to another embodiment of the present invention, which is obtained by improving the gasket/bush-based battery watertightness structure according to the related art. FIG. 13 illustrates, for example, a watertightness structure that may be applied to the maintenance window 40 illustrated in FIGS. 6 and 7, but the present invention is not limited thereto. All watertightness structures in which a gasket is present between a case and a cover may be applied.

Similar to that illustrated in FIG. 10, the assembly hardware (in the present embodiment, a blind nut 103) is press-fitted in a cover 101 of the BSA, and a gasket 105 is fitted between the cover 101 and a maintenance window cover 107. Further, the counterpart assembly hardware (that is, a bolt 109) is inserted into the blind nut 103 through through-holes of the maintenance window cover 107 and the gasket 105 to fasten the maintenance window cover 107 and the blind nut 103.

Even in the present embodiment, the gasket 105 does not have the bush 46 (in FIG. 10). Instead, the thickness (height) of a head part flange 104 of the blind nut 103 is increased, and thus this increase corresponds to a form in which the existing bush is located between the cover 101 and the maintenance window cover 107. Accordingly, the problem of deformation of the flange part of the bush, when the counterpart assembly hardware (that is, a fastening bolt 109) is fastened, due to a relatively weak flange structure of the bush can be overcome. At the same time, the blind nut 103 instead of the bush may counter the axial force when the counterpart assembly hardware is fastened, to support upper and lower compression limits of the gasket 105, and thus fastening torque can be maintained.

Further, an inner extension 106 is added so that a gasket flesh is further inserted into the through-hole of the gasket 105 to surround the head part flange 104 of the blind nut 103. As the gasket 105 is compressed between the cover 101 and the maintenance window cover 107, the inner extension 106 is further inserted and expanded into the through-hole and thus may approach or come into close contact with a side surface of the head part flange 104 of the blind nut 103. Further, since there is no bush in the gasket 105, the watertightness between the cover 101 and the maintenance window cover 107 is completely operated by the compression of the gasket 105, and thus penetration of moisture into a corresponding space (mark C′) therebetween is blocked (mark D′).

FIG. 14 illustrates an embodiment modified from that in FIG. 13 and an embodiment to which the present invention is applied when the cover 101 is made of an aluminum extrusion material and is relatively thicker than the maintenance window cover 107 (in contrast, FIG. 13 illustrates a case in which the cover 101 is made of a steel material). That is, an embodiment when the cover 101 on the lower side is thicker than the maintenance window cover 107 on the upper side is illustrated, and the configuration and the principle of operation thereof are the same as those of the embodiment illustrated in FIG. 13.

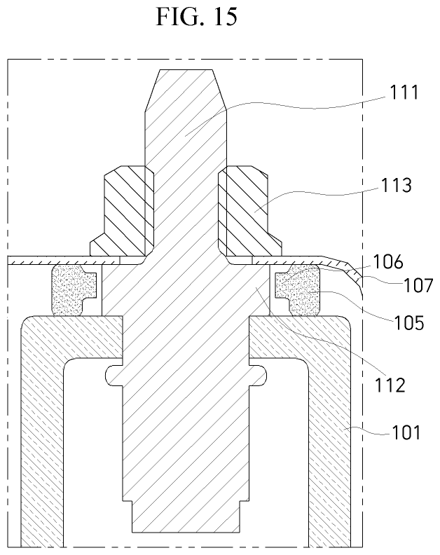

Further, FIG. 15 illustrates an embodiment when not the blind nut but a blind bolt 111 is used as the assembly hardware used in the embodiment of FIG. 14.

The blind bolt 111 as the assembly hardware is press-fitted in the cover 101 made of an aluminum extrusion material, the maintenance window cover 107 is covered so that the blind bolt 111 is fitted therein, and a fastening nut 113 as the counterpart assembly hardware is fastened to the exposed blind bolt 111.

Similar to the cases of FIGS. 13 and 14, instead of removing the bush 46 (in FIG. 10) from the gasket 105, the thickness of an anchor flange 112 of the blind bolt 111 is increased so that the anchor flange 112 occupies a space between the cover 101 and the maintenance window cover 107. Further, the cover 101 and the maintenance window cover 107 are fastened using the fastening nut 113 as the counterpart assembly hardware. The improvement of the watertight action of the gasket 105 and the effect thereof is similar to the case of the blind nut 103 of FIGS. 13 and 14.

According to the present invention, since a bush is not used in a gasket, a process of coupling the gasket and the bush is omitted, thereby reducing a cycle time and production costs, and solving a problem of defects occurring when the gasket is moved.

Further, since the bush is removed from the gasket, even when the assembly hardware (fastening bolts and fastening nuts) is tightened and loosened multiple times, the gasket is not damaged and deformed, the compression of the gasket is strengthened, and thus the introduction of moisture into a battery is effectively blocked.

Hereinabove, the present invention has been described in detail through the exemplary embodiments of the present invention. However, those skilled in the art to which the present invention pertains can understand that the present invention can be implemented in specific forms different from those disclosed in the present specification without changing the technical spirit or essential features thereof.

What is claimed is:

1. A battery watertightness structure comprising:
a first member;
a second member that covers the first member;
a gasket located between the first member and the second member;
assembly hardware fixed to a hole in the first member; and
counterpart assembly hardware that is assembled with the assembly hardware through a hole in the second member and fastens the first member and the second member and the gasket therebetween,
wherein a height of a portion of the assembly hardware, which is located between the first member and the second member, is configured to support a compression limit of the gasket.

2. The battery watertightness structure of claim 1, wherein the assembly hardware includes an insert bolt.

3. The battery watertightness structure of claim 1, wherein the assembly hardware includes an insert nut.

4. The battery watertightness structure of claim 1, wherein the assembly hardware includes a blind bolt.

5. The battery watertightness structure of claim 1, wherein the assembly hardware includes a blind nut.

6. The battery watertightness structure of claim 1, wherein the gasket includes an extension extending toward the assembly hardware.

7. The battery watertightness structure of claim 1, wherein the first member is made of one of steel, aluminum, and a synthetic resin.

8. The battery watertightness structure of claim 1, wherein the first member includes a case of a battery system assembly (BSA) for an electric vehicle, and
the second member includes a cover of the BSA.

9. The battery watertightness structure of claim 1, wherein the first member includes a cover of a battery system assembly (BSA) for an electric vehicle, and
the second member includes a maintenance window cover of the BSA.

10. The battery watertightness structure of claim 1, wherein the height of the portion of the assembly hardware, which is located between the first member and the second member, is configured to support the compression limit of the gasket against an axial force when the counterpart assembly hardware is assembled between the first member and the second member.

11. A method of water-tightening a battery, comprising:
disposing a gasket between a first member and a second member that covers the first member;
fixing assembly hardware to a hole formed in the first member; and
assembling counterpart assembly hardware with the assembly hardware through a hole formed in the second member to fasten the first member and the second member and the gasket therebetween,
wherein a height of a portion of the assembly hardware, which is located between the first member and the second member, supports a compression limit of the gasket against an axial force when the counterpart assembly hardware is assembled between the first member and the second member.

12. The method of claim 11, wherein the gasket includes an extension extending toward the assembly hardware.

13. The method of claim 11, wherein the first member includes a case of a battery system assembly (BSA) for an electric vehicle, and
the second member includes a cover of the BSA.

14. The method of claim 11, wherein the first member includes a cover of a battery system assembly (BSA) for an electric vehicle, and
the second member includes a maintenance window cover of the BSA.
